(19) United States
(12) Patent Application Publication
(10) Pub. No.: US 2015/0370012 A1
(43) Pub. Date: Dec. 24, 2015

(54) IMAGING APPARATUS

(71) Applicant: CANON KABUSHIKI KAISHA, Tokyo (JP)

(72) Inventor: Keiichiro Ishihara, Yokohama-shi (JP)

(21) Appl. No.: 14/741,593

(22) Filed: Jun. 17, 2015

(30) Foreign Application Priority Data
Jun. 18, 2014 (JP) 2014-125726

(51) Int. Cl. G02B 6/06; H04N 5/374; H04N 5/225

(52) U.S. Cl. CPC G02B 6/06; H04N 5/2254; H04N 5/2253; H04N 5/374; G02B 5/005

(57) ABSTRACT

An imaging apparatus includes an imaging optical system, an imaging element, and an optical fiber bundle composed of a plurality of optical fibers configured to guide light from the imaging optical system to the imaging element. Each of the optical fibers includes a core portion and a clad portion around the core portion. A diameter of the core portion on a light emit face of the optical fibers is larger than a diameter of the core portion on a light incident face. An optical fiber not parallel to an optical axis of the imaging optical system satisfies the following expression:

0≦αᵢ<ωᵢ
where αᵢ represents an inclination angle of the optical fiber with respect to the optical axis on the light incident face, and ωᵢ represents an angle of a principal ray incident on the optical fiber from the imaging optical system with respect to the optical axis.

### BACKGROUND OF THE INVENTION

1. Field of the Invention

The present invention relates to an imaging apparatus.

2. Description of the Related Art

There have been developed imaging apparatuses which include an optical fiber bundle (optical waveguide) composed of a plurality of optical fibers (optical waveguide members) and in which imaging light enters an imaging element (imaging unit) via the optical fibers.

Japanese Patent Application Laid-Open No. 7-087371 discloses an imaging apparatus in which optical waveguide members that constitute an optical waveguide are different in size between a small light incident surface and a large light emit surface. In this imaging apparatus, the smaller end face of the optical waveguide serves as the light incident surface, and the larger end face of the optical waveguide serving as the light emit surface is provided with an imaging element.

In the imaging apparatus of Japanese Patent

Application Laid-Open No. 7-087371, when the inclination angle of the axis of an optical waveguide member with respect to the optical axis is larger than the incident angle of imaging light on the optical waveguide member, the emergent angle of the imaging light emerging from the optical waveguide member cannot be smaller than the incident angle. For this reason, the incident angle of the imaging light on the imaging element becomes large, and this may lower the coupling efficiency between the imaging light and pixels of the imaging element. The coupling efficiency is pronouncedly lowered particularly in a peripheral part of the imaging element where the incident angle of the imaging light is large.

### SUMMARY OF THE INVENTION

An imaging apparatus according to an aspect of the present invention includes an imaging optical system, an imaging element, and an optical fiber bundle composed of a plurality of optical fibers configured to guide light from the imaging optical system to the imaging element. Each of the plurality of optical fibers includes a core portion and a clad portion disposed around the core portion. A diameter of the core portion on a light emit face of the optical fibers is larger than a diameter of the core portion on a light incident face of the optical fibers. An optical fiber not parallel to an optical axis of the imaging optical system satisfies the following expression:

0≦αᵢ<ωᵢ

where αᵢ represents an inclination angle of the optical fiber with respect to the optical axis of the imaging optical system on the light incident face, and ωᵢ represents an angle of a principal ray incident on the optical fiber from the imaging optical system with respect to the optical axis of the imaging optical system.

Further features of the present invention will become apparent from the following description of exemplary embodiments with reference to the attached drawings.

### BRIEF DESCRIPTION OF THE DRAWINGS

FIG. 1A illustrates a frame format of an example of an imaging apparatus according to a first embodiment.

FIG. 1B illustrates a frame format of a part of a cross section of an optical fiber bundle in the first embodiment, taken in a direction parallel to a light receiving surface of an imaging element.

FIG. 2A explains the inclination angle of an optical fiber on a light incident face.

FIG. 2B explains the inclination angle of the optical fiber on a light emit face.

FIG. 2C illustrates how light propagates in the optical fiber.

FIG. 3 explains light propagating in an optical fiber that constitutes the optical fiber bundle of the first embodiment.

FIG. 4A illustrates a frame format of an example of an imaging apparatus according to a second embodiment.

FIG. 4B illustrates how light propagates in an optical fiber in the second embodiment.

FIG. 5 illustrates a frame format of an example of an imaging apparatus according to a third embodiment.

FIG. 6 illustrates a frame format of an example of an imaging apparatus according to a fourth embodiment.

### DESCRIPTION OF THE EMBODIMENTS

While the present invention will be described in detail with reference to embodiments and the drawings, it is not limited to the structures of the embodiments.

### First Embodiment

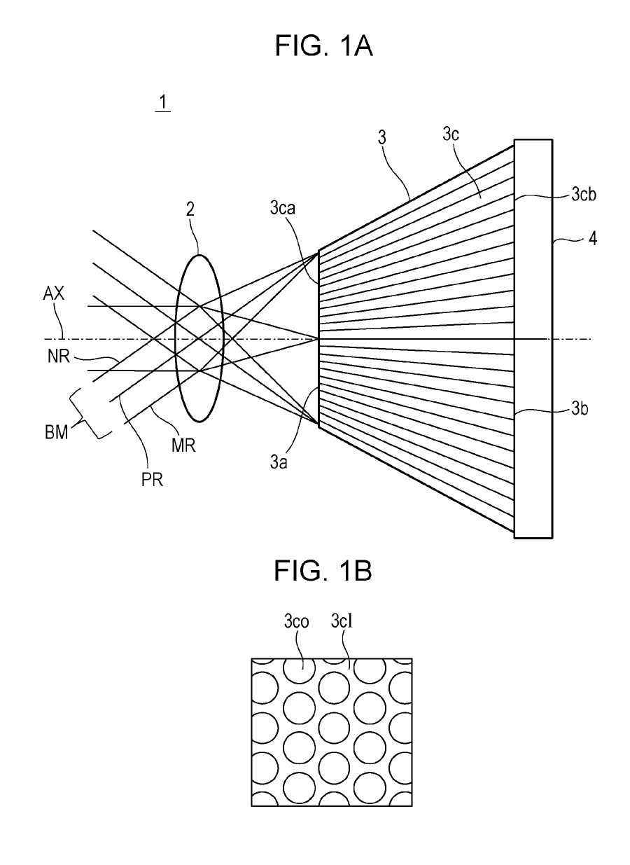

FIG. 1A illustrates a frame format of an example of an imaging apparatus according to a first embodiment. An imaging apparatus 1 according to the first embodiment includes an imaging optical system (imaging optics) 2, an optical fiber bundle 3 serving as an image transmission unit, and a sensor 4 serving as an imaging element. The imaging optical system 2, the optical fiber bundle 3, and the sensor 4 are arranged so that an image of the imaging optical system 2 is transmitted to the sensor 4 through the optical fiber bundle 3. The optical fiber bundle 3 is composed of a plurality of optical fibers 3c that guide light from the imaging optical system 2 to the sensor 4. Specifically, the optical fibers 3c receive imaging light BM via the imaging optical system 2, cause the imaging light BM to propagate in the optical fibers 3c, and guide the imaging light BM to pixels of the sensor 4. The imaging light BM includes a principal ray PR passing through the center of an exit pupil of the imaging optical system 2, an upper marginal ray NR, and a lower marginal ray MR.

A light incident surface 3a and a light emit surface 3b of the optical fiber bundle 3 both have a planar shape. The optical fiber bundle 3 is disposed so that the light emit surface 3b thereof is in close contact with a light incident surface of the sensor 4.

The axes of the optical fibers 3c provided in a peripheral part of the optical fiber bundle 3 are inclined with respect to an optical axis AX of the imaging optical system 2. The inclination angles are set to satisfy the condition that the imaging light BM incident on the optical fibers 3c should be totally reflected within the optical fibers 3c. This structure suppresses the decrease in transmittance of the optical fibers 3c in the peripheral part of the optical fiber bundle 3.

The optical axis AX of the imaging optical system 2 refers to a straight line that passes through the center of the exit pupil of the imaging optical system 2 and is perpendicular to the light receiving surface of the sensor 4. Further, the optical axis AX passes through the center of the light incident surface 3a of the optical fiber bundle 3. That is, a straight line connecting the center of the exit pupil of the imaging optical system 2 and the center of the light incident surface 3a of the optical fiber bundle 3 coincides with the optical axis AX.

FIG. 1B illustrates a part of a cross section of the optical fiber bundle 3 parallel to the light receiving surface of the sensor 4. In this cross section, core portions 3co are arranged in the form of a triangular lattice, and clad portions 3c1 are disposed between the core portions 3co. In this way, each optical fiber 3c is composed of a core portion 3co and a clad portion 3c1 disposed around the core portion 3co. While the core portions 3co are arranged in the form of a triangular lattice in FIG. 1B, the present invention is not limited thereto. For example, the core portions 3co may be arranged in the form of an arbitrary lattice such as a square lattice or a rhombic lattice. Alternatively, the core portions 3co may be arranged at random as long as the clad portions 3c1 are disposed between the core portions 3co. Further alternatively, it is possible to use an optical fiber bundle in which a region including core portions 3co arranged in the form of a lattice and a region including core portions 3co arranged at random are mixed.

The optical fibers 3c of the optical fiber bundle 3 may be or not be in one-to-one correspondence with the pixels in the sensor 4. For example, a part of the imaging light BM propagating through an optical fiber 3c may be received by a certain pixel in the sensor 4, and the other part of the imaging light BM may be received by a different pixel. Alternatively, a certain pixel in the sensor 4 may receive the imaging light BM propagating through a plurality of optical fibers 3c.

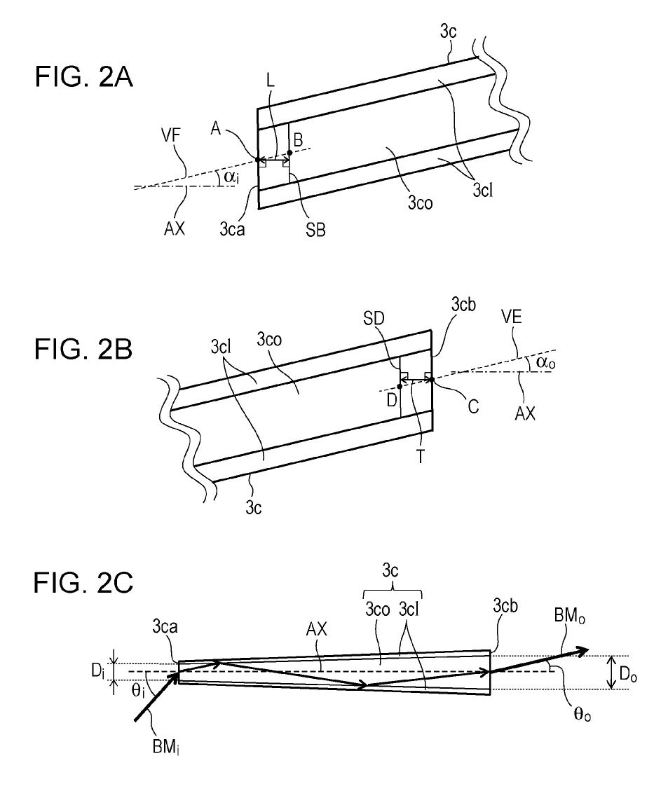

In each optical fiber 3c of the first embodiment, the inclination angle of the optical fiber 3c on a light incident face 3ca and the inclination angle of the optical fiber 3c on a light emit face 3cb are equal to each other. As illustrated in FIG. 2A, the inclination angle of the optical fiber 3c on the light incident face 3ca is an angle αᵢ formed by an axis VF of the optical fiber 3c and the optical axis AX on the light incident face 3ca. The angle αᵢ is more than or equal to 0.0 degrees and less than 90.0 degrees. The axis VF is defined as follows. That is, the axis VF is a straight line that connects a center A of a cross section of the core portion 3co on the light incident face 3ca of the optical fiber 3c and a center point B of a cross section SB shifted from the center A toward the inside of the core portion 3co by a diameter L of the core portion 3co on the light incident face 3ca of the optical fiber 3c.

On the other hand, as illustrated in FIG. 2B, the inclination angle of the optical fiber 3c on the light emit face 3cb is an angle αₒ formed by an axis VE of the optical fiber 3c and the optical axis AX on the light emit face 3cb. The angle αₒ is more than or equal to 0.0 degrees and less than 90.0 degrees. The axis VE is defined as follows. That is, the axis VE is a straight line that connects a center C of a cross section of the core portion 3co on the light emit face 3cb of the optical fiber 3c and a center point D of a cross section SD of the core portion 3co shifted from the center C toward the inside of the core portion 3co by a diameter T of the core portion 3co on the light emit face 3cb of the optical fiber 3c. In the first embodiment, the inclination angle αₒ and the inclination angle αᵢ of the optical fiber 3c are equal to each other. That is, αₒ=αᵢ.

FIG. 2C illustrates how light propagates in the optical fiber 3c that constitutes the optical fiber bundle 3. However, the optical fiber 3c disposed on the optical axis AX is illustrated in FIG. 2C. Both of the inclination angle αᵢ on the light incident face 3ca and the inclination angle αₒ on the light emit face 3cb are 0. Light BMᵢ incident at an incident angle θᵢ propagates in the core portion 3co while being totally reflected by a boundary surface between the core portion 3co and the clad portion 3c1. This optical fiber 3c is structured such that a diameter Dₒ of the core portion 3co on the light emit face 3cb is larger than a diameter Dᵢ of the core portion 3co on the light incident face 3ca. Herein, Dₒ/Dᵢ is referred to as a taper ratio R of the optical fiber 3c. As illustrated in FIG. 2C, the taper ratio R of each optical fiber 3c is higher than 1 in the first embodiment.

Light propagating in the optical fiber 3c having the above-described structure is converted into light with an emergent angle θₒ smaller than the incident angle θᵢ, and is emitted as emit light BMₒ. The emergent angle θₒ is given by the following Expression 1 using the taper ratio R and the incident angle θᵢ:

sin(θₒ)=sin(θᵢ)/R (1)

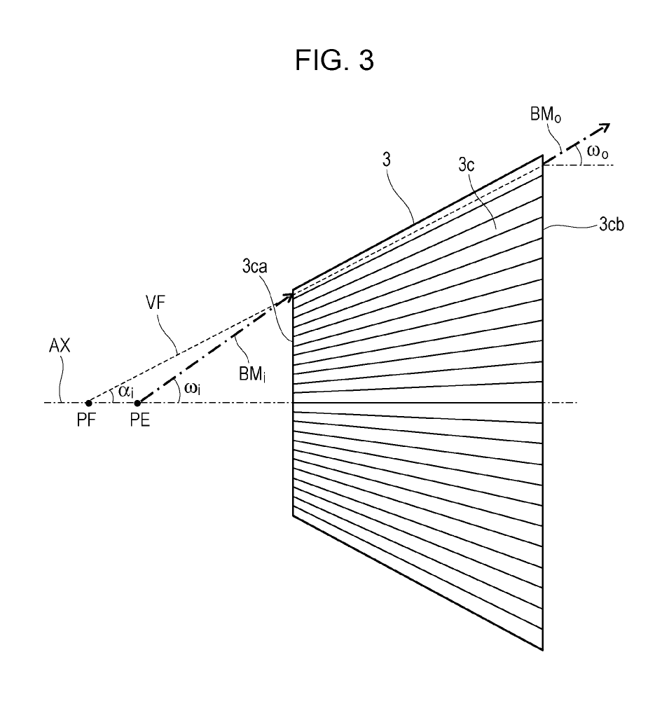

FIG. 3 illustrates how light propagates in the optical fiber 3c which far from and not parallel to the optical axis AX of the optical fiber bundle 3 of the first embodiment. Here, ωᵢ represents the incident angle of incident light BMᵢ emitted from the center PE of the exit pupil of the imaging optical system 2 and entering the light incident face 3ca of the optical fiber 3c. The light BMᵢ refers to the principal ray PR of the imaging light BM illustrated in FIG. 1A. Further, ωₒ represents the emergent angle of emit light BMₒ such that the incident light BMᵢ propagates in the optical fiber 3c and is emitted from the light emit face 3cb.

In the first embodiment, an intersection point PF of the axis VF of the optical fiber 3c and the optical axis AX on the light incident face 3ca is disposed closer to the object side than the center PE of the exit pupil of the imaging optical system 2. That is, the inclination angle αᵢ on the light incident face 3ca of the optical fiber 3c is smaller than ωᵢ. This is expressed by the expression 0≦αᵢ<ωᵢ. The optical fiber 3c on the optical axis AX is such that αᵢ=0. The other optical fibers 3c at positions far from the optical axis AX satisfy the condition that 0<αᵢ<ωᵢ. For this reason, the incident light BMᵢ propagates in the optical fiber 3c, is converted into light with the emergent angle ωₒ, and is emitted as emit light BMₒ. The emergent angle ωₒ is expressed by the following Expression 2:

$${ω}_{o} = {α}_{i} + {sin}^{- 1} [ \frac{sin ( {ω}_{i} - {α}_{i} )}{R} ] \qquad ( 2 )$$

where αᵢ represents the inclination angle of the optical fiber 3c far from the optical axis AX of the imaging optical system 2 on the light incident face 3ca, ωᵢ represents the incident angle of 0.0 degrees or more and less than 90.0 degrees of the principal ray passing through the center PE of the exit pupil of the imaging optical system 2 and entering the light incident face 3ca of the optical fiber 3c, and R represents the ratio (taper ratio) of the diameter of the core portion 3co on the light emit face 3cb of the optical fiber 3c to the diameter of the core portion 3co on the light incident face 3ca of the optical fiber 3c.

As can be known from Expression 2, since the taper ratio R is more than 1, the emergent angle ωₒ is close to the inclination angle αᵢ. As described above, since αᵢ<ωᵢ, αᵢ<ωₒ<ωᵢ, and the emergent angle ωₒ is converted into an angle smaller than the incident angle ωᵢ. Since the light receiving surface of the sensor 4 is perpendicular to the optical axis AX, light emitted from the optical fiber 3c at the emergent angle ωₒ enters the light receiving surface of the sensor 4 as light with the incident angle ωₒ in the direction perpendicular to the light receiving surface of the sensor 4.

In general, in the sensor 4 using a CMOS or the like, the photoreceptive sensitivity to the incident light from the direction perpendicular to the light receiving surface is the highest, and the photoreceptive sensitivity to the incident light decreases as the inclination angle with respect to the perpendicular direction increases. By using the optical fiber bundle 3 of the first embodiment, the incident angle of light incident on the light receiving surface of the sensor 4 can be made smaller than when the optical fiber bundle 3 is not used. For this reason, the optical fiber bundle 3 of the first embodiment can enhance the coupling efficiency between the imaging light BM and the pixels of the sensor 4.

In contrast, a case in which αᵢ>ωᵢ will be considered. In this case, the emergent angle ωₒ is also close to the inclination angle αᵢ. Then, since αᵢ>ωᵢ, αᵢ>ωₒ>ωᵢ, and the emergent angle ωₒ is converted into an angle larger than the incident angle ωᵢ. For this reason, when an optical fiber bundle such that αᵢ>ωᵢ is used, the incident angle of light incident on the light receiving surface of the sensor becomes larger than when such an optical fiber bundle is not provided. As a result, the coupling efficiency between the imaging light and the pixels of the sensor decreases.

In the typical sensor 4, the photoreceptive sensitivity is the highest when the incident angle of the incident light on the sensor 4 is 0.0 degrees. The photoreceptive sensitivity is about 80% of the highest photoreceptive sensitivity when the incident angle is ±15.0 degrees, is about 50% of the highest photoreceptive sensitivity when the incident angle is ±20 degrees, and is about 10% of the highest photoreceptive sensitivity when the incident angle is ±30.0 degrees. Thus, to efficiently perform imaging with the sensor 4, the incident angle on the sensor 4, that is, the emergent angle ωₒ from the light emit face 3cb of the optical fiber 3c is preferably 30.0 degrees or less, and more preferably 20.0 degrees or less. Further, the emergent angle ωₒ is most preferably 15.0 degrees or less. That is, it is preferable that the optical fiber 3c far from the optical axis should satisfy any of the following Expressions 3 to 5:

$$\begin{matrix}{α}_{i} + {sin}^{- 1} [ \frac{sin ( {ω}_{i} - {α}_{i} )}{R} ] < 30 [ deg ] & ( 3 ) \\ {α}_{i} + {sin}^{- 1} [ \frac{sin ( {ω}_{i} - {α}_{i} )}{R} ] < 20 [ deg ] & ( 4 ) \\ {α}_{i} + {sin}^{- 1} [ \frac{sin ( {ω}_{i} - {α}_{i} )}{R} ] < 15 [ deg ] & ( 5 )\end{matrix}$$

An incident angle on the sensor 4 such that the photoreceptive sensitivity of the sensor 4 becomes 10% of the highest photoreceptive sensitivity is designated as θ_{A}. An incident angle on the sensor 4 such that the photoreceptive sensitivity of the sensor 4 becomes 50% of the highest photoreceptive sensitivity is designated as θ_{B}. An incident angle on the sensor 4 such that the photoreceptive sensitivity of the sensor 4 becomes 80% of the highest photoreceptive sensitivity is designated as θ_{C}. In this case, the optical fiber 3c far from the optical axis may satisfy any of Expressions 6 to 8:

$$\begin{matrix}{α}_{i} + {sin}^{- 1} [ \frac{sin ( {ω}_{i} - {α}_{i} )}{R} ] < {θ}_{A} & ( 6 ) \\ {α}_{i} + {sin}^{- 1} [ \frac{sin ( {ω}_{i} - {α}_{i} )}{R} ] < {θ}_{B} & ( 7 ) \\ {α}_{i} + {sin}^{- 1} [ \frac{sin ( {ω}_{i} - {α}_{i} )}{R} ] < {θ}_{C} & ( 8 )\end{matrix}$$

For example, it is assumed that the incident angle ωᵢ of the principal ray of imaging light is 40.0 degrees in the farthest optical fiber 3c from the optical axis AX. In this case, when the inclination angle αᵢ is 20.0 degrees and the taper ratio R is 2.0, the emergent angle ωₒ is 29.8 degrees according to Expression 2, and even the farthest optical fiber 3c from the optical axis AX satisfies Expression 3 and Expression 6.

By thus appropriately setting the inclination angle αᵢ and the taper ratio R in the farthest optical fiber 3c from the optical axis AX, any of Expressions 3 to 8 can be satisfied. In the optical fiber 3c on the optical axis AX, both αᵢ and ωᵢ are 0. Hence, ωₒ is 0.

By setting the taper ratio R at 2.0 or more, the emergent angle ωₒ can be decreased further. When the taper ratio R is changed by the position of the optical fiber 3c, only the diameter Dᵢ of the core portion on the light incident face 3ca of the optical fiber 3c may be changed, only the diameter Dₒ of the core portion on the light emit face 3cb of the optical fiber 3c may be changed, or both of the diameters may be changed.

The taper ratio R may be common to all of the optical fibers 3c, or may be changed individually. Particularly in the optical fibers 3c in the peripheral part of the optical fiber bundle 3, the incident angle ωᵢ is large. Hence, the taper ratio R of the optical fiber 3c relatively far from the optical axis AX is preferably higher than that of the optical fiber 3c relatively close to the optical axis AX. This can further enhance the coupling efficiency between the pixels of the sensor 4 corresponding to the optical fibers 3c in the peripheral part of the optical fiber bundle 3 and the imaging light. Further, it is preferable that the taper ratio R of the optical fiber 3c should increase as the distance of the optical fiber 3c from the optical axis AX increases.

The inclination angle αᵢ may be common to all of the optical fibers 3c, or may be changed individually. In particular, the optical fiber bundle 3 is preferably structured such that the inclination angle αᵢ of the optical fiber 3c relatively far from the optical axis AX is smaller than that of the optical fiber 3c relatively close to the optical axis AX. This can further enhance the coupling efficiency between the pixels of the sensor 4 corresponding to the optical fibers 3c in the peripheral part of the optical fiber bundle 3 and the imaging light. Further, it is preferable that the inclination angle αᵢ of the optical fiber 3c should decrease as the distance of the optical fiber 3c from the optical axis AX increases.

Preferably, the taper ratio R and the inclination angle αᵢ of each optical fiber 3c are appropriately set to decrease the difference in the coupling efficiency of the imaging light and the pixel between the center and the peripheral part of the sensor 4.

According to the above-described first embodiment, it is possible to provide an imaging apparatus that enhances the coupling efficiency in an imaging element.

### Second Embodiment

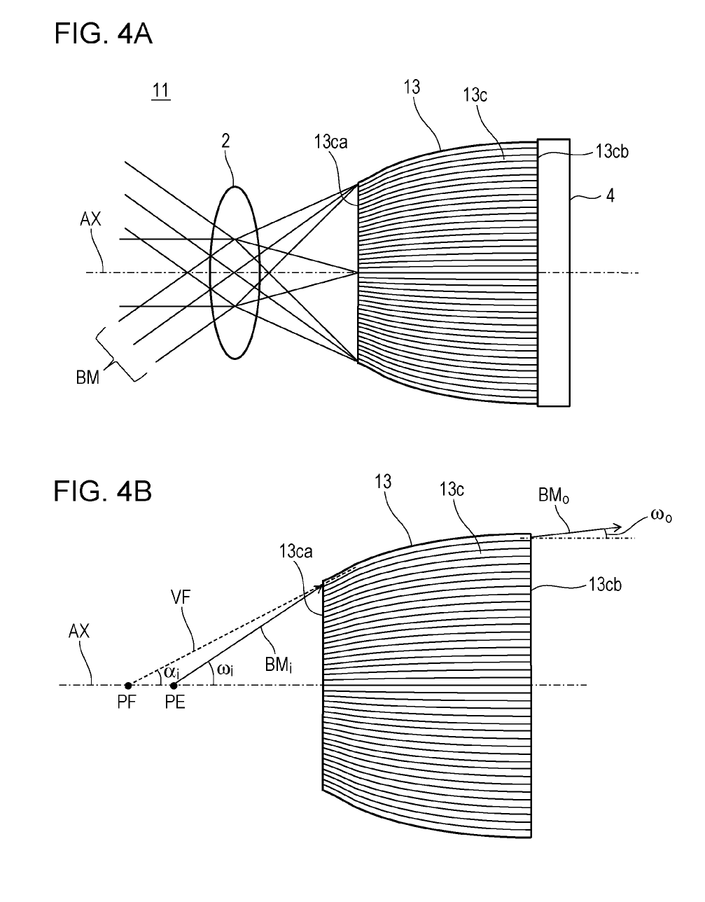

FIG. 4A illustrates a frame format of an example of an imaging apparatus 11 according to a second embodiment. The second embodiment is different from the first embodiment in the structure of an optical fiber bundle, but is equal to the first embodiment in other respects. Specifically, in an optical fiber bundle 13 of the imaging apparatus 11, an inclination angle αᵢ on a light incident face 13ca of each optical fiber 13c is different from an inclination angle αₒ on a light emit face 13cb of the optical fiber 13c. More specifically, the inclination angle αₒ is smaller than the inclination angle αᵢ. That is, αₒ<αᵢ.

FIG. 4B illustrates how light propagates in the optical fiber 13c in the second embodiment. Similarly to the first embodiment, an incident angle of incident light BMᵢ emitted from a center PE of an exit pupil of an imaging optical system 2 and entering the light incident face 13ca of the optical fiber 13c is designated as ωᵢ. Further, an emergent angle of the incident light BMᵢ propagating in the optical fiber 13c and emitted as emit light BMₒ from the light emit face 13cb is designated as ωₒ. The emergent angle ωₒ is expressed by the following Expression 9:

$${ω}_{o} = {α}_{o} + {sin}^{- 1} [ \frac{sin ( {ω}_{i} - {α}_{i} )}{R} ] \qquad ( 9 )$$

where αᵢ represents the inclination angle of the optical fiber 13c far from the optical axis AX of the imaging optical system 2 on the light incident face 13ca, αₒ represents the inclination angle of the optical fiber 13c far from the optical axis AX of the imaging optical system 2 on the light emit face 13cb, ωᵢ represents the incident angle of the principal ray passing through the center PE of the exit pupil of the imaging optical system 2 and entering the light incident face 13ca of the optical fiber 3c, and R represents the taper ratio of the optical fiber 13c.

As can be known from Expression 9, since the taper ratio R is more than 1, the emergent angle ωₒ is close to the inclination angle αₒ. Similarly to the first embodiment, since αᵢ<ωᵢ and αₒ<αᵢ, as described above, αₒ<ωₒ<ωᵢ, and the emergent angle ωₒ is converted into an angle smaller than the incident angle ωᵢ. Hence, when the optical fiber bundle 13 of the second embodiment is used, the incident angle of light on a light receiving surface of a sensor 4 can be made smaller than when the optical fiber bundle 13 is not used. For this reason, the optical fiber bundle 13 of the second embodiment can enhance the coupling efficiency between imaging light BM and pixels of the sensor 4.

As described in conjunction with the first embodiment, in the typical sensor 4, the photoreceptive sensitivity is the highest when the incident angle is 0.0 degrees. The photoreceptive sensitivity is about 80% of the highest photoreceptive sensitivity when the incident angle is ±15.0 degrees, is about 50% of the highest photoreceptive sensitivity when the photoreceptive sensitivity is ±20.0 degrees, and is about 10% of the highest photoreceptive sensitivity when the incident angle is ±30.0 degrees. Thus, to efficiently perform imaging with the sensor 4, the incident angle on the sensor 4, that is, the emergent angle ωₒ from the light emit face 13cb of the optical fiber 13c is preferably 30.0 degrees or less, and more preferably 20.0 degrees or less. Further, the emergent angle ωₒ is most preferably 15.0 degrees or less. That is, it is preferable that the optical fiber 13c far from the optical axis should satisfy any of the following Expressions 10 to 12:

$$\begin{matrix}{α}_{o} + {sin}^{- 1} [ \frac{sin ( {ω}_{i} - {α}_{i} )}{R} ] \leq 30 [ deg ] & ( 10 ) \\ {α}_{o} + {sin}^{- 1} [ \frac{sin ( {ω}_{i} - {α}_{i} )}{R} ] \leq 20 [ deg ] & ( 11 ) \\ {α}_{o} + {sin}^{- 1} [ \frac{sin ( {ω}_{i} - {α}_{i} )}{R} ] \leq 15 [ deg ] & ( 12 )\end{matrix}$$

The incident angle on the sensor 4 such that the photoreceptive sensitivity of the sensor 4 becomes 10% of the highest photoreceptive sensitivity is designated as θ_{A}. The incident angle on the sensor 4 such that the photoreceptive sensitivity of the sensor 4 becomes 50% of the highest photoreceptive sensitivity is designated as θ_{B}. The incident angle on the sensor 4 such that the photoreceptive sensitivity of the sensor 4 becomes 80% of the highest photoreceptive sensitivity is designated as θ_{C}. In this case, the optical fiber 13c far from the optical axis may satisfy any of Expressions 13 to 15:

$$\begin{matrix}{α}_{o} + {sin}^{- 1} [ \frac{sin ( {ω}_{i} - {α}_{i} )}{R} ] \leq {θ}_{A} & ( 13 ) \\ {α}_{o} + {sin}^{- 1} [ \frac{sin ( {ω}_{i} - {α}_{i} )}{R} ] \leq {θ}_{B} & ( 14 ) \\ {α}_{o} + {sin}^{- 1} [ \frac{sin ( {ω}_{i} - {α}_{i} )}{R} ] \leq {θ}_{C} & ( 15 )\end{matrix}$$

For example, it is assumed that the incident angle ωᵢ of the principal ray of the imaging light BM is 40.0 degrees in the farthest optical fiber 13c from the optical axis AX. In this case, when the inclination angle αᵢ is 20.0 degrees and the taper ratio R is 2.0, the emergent angle ωₒ is 9.8 degrees according to Expression 9. This can satisfy all of Expressions 10 to 15. When the inclination angle αₒ in the above-described numerical example is changed from 0.0 degrees to 10.0 degrees, the emergent angle ωₒ becomes 19.8 degrees. This can satisfy Expressions 10, 11, 13, and 14. Even when the incident angle ωᵢ is a large value such as 60.0 degrees, the emergent angle ωₒ becomes 19.2 degrees, for example, when the inclination angle αᵢ is 35.0 degrees, the inclination angle αₒ is 7.0 degrees, and the taper ratio R is 2.0. This can satisfy Expressions 10, 11, 13, and 14.

By thus appropriately setting the inclination angle αᵢ, the inclination angle αₒ, and the taper ratio R, the incident angle on the sensor 4 can be made closer to the angle of the direction perpendicular to the sensor 4. As described in conjunction with the first embodiment, it is preferable to set the inclination angle αᵢ and the taper ratio R according to the position of each optical fiber 13c in the optical fiber bundle 13. Similarly to the inclination angle αᵢ, it is also preferable to set the inclination angle α^{o} according to the position of each optical fiber 13c in the optical fiber bundle 13. As the inclination angle αₒ decreases, the emergent angle ωₒ of the emit light from the optical fiber 13c decreases. For this reason, it is preferable that the inclination angle αₒ of the optical fiber 13c relatively far from the optical axis AX should be smaller than that of the optical fiber 13c relatively close to the optical axis AX. Further, it is preferable that the inclination angle αₒ of the optical fiber 13c should decrease as the distance of the optical fiber 13c from the optical axis AX increases.

The right side of Expression 2 in the first embodiment and the right side of Expression 9 in the second embodiment are different in the first term. However, when it is considered that Expression 2 corresponds to a special case in which αₒ=αᵢ in Expression 9, Expressions 2 and 9 are the same. While the inclination angle αₒ of the optical fiber 13c on the light emit face 13cb is set to be smaller than the inclination angle αᵢ of the optical fiber 13c on the light incident face 13ca in the second embodiment, as described above, it may be only necessary to satisfy the condition that 0≦αₒ≦αᵢ. In this case, as shown in FIGS. 4A and 4B, it may be possible to provide a fiber bundle 3 where a fiber is not parallel to the optical axis AX at light incident face 13ca, but the same fiber at the light emit face 13cb may be substantially parallel to the optical axis AX. In that case, the condition 0=αₒ≦αᵢ may be further satisfied. The first embodiment exemplifies the case in which αₒ=αᵢ. However, in the second embodiment of FIGS. 4A and 4B, the case in which αₒ<αᵢ is exemplified.

According to the above-described second embodiment, it is possible to provide an imaging apparatus that enhances the coupling efficiency in an imaging element.

### Third Embodiment

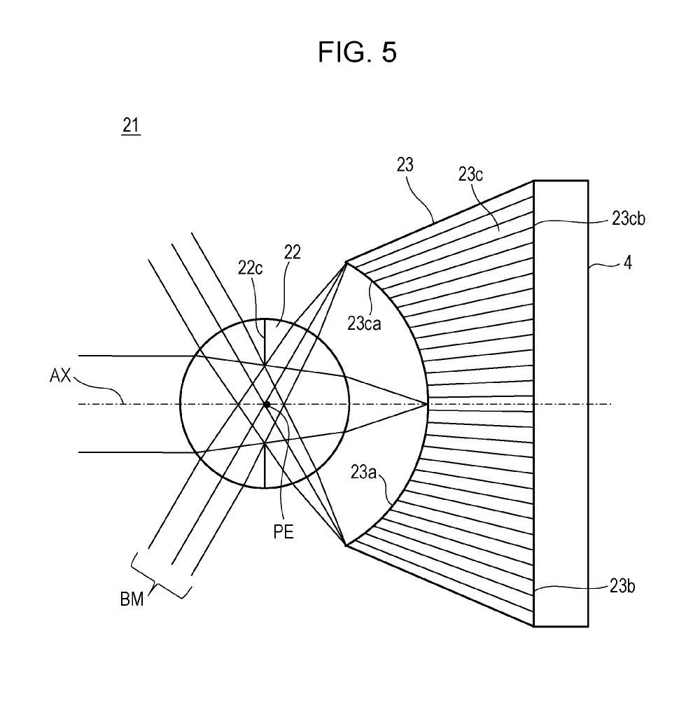

FIG. 5 illustrates a frame format of an example of an imaging apparatus 21 according to a third embodiment. The third embodiment is different from the second embodiment in the structures of an imaging optical system and an optical fiber bundle, and is the same in other respects.

An imaging optical system 22 in the third embodiment is a ball lens (spherical lens) having point symmetry. The ball lens includes an aperture stop 22c. A center PE of an exit pupil of the imaging optical system 22 is at the center of the ball lens. The center PE of the exit pupil of the imaging optical system 22 is also located at the center of an aperture of the aperture stop 22c. An imaging surface of the imaging optical system 22 has a curved shape whose curvature center is at the center PE of the exit pupil. For this reason, a light incident surface 23a of an optical fiber bundle 23 has the same curved shape as that of the imaging surface of the imaging optical system 22. More specifically, the light incident surface 23a has a concave surface substantially equal to that of the imaging surface of the ball lens. The light incident surface 23a of the optical fiber bundle 23 is formed as a smooth optical surface by spherical surface polishing, similarly to a glass lens. This polishing technique can suppress scattering occurring on a surface of the light incident surface 23a. In contrast, a light emit surface 23b of the optical fiber bundle 23 has a planar shape. The optical fiber bundle 23 is disposed so that the light emit surface 23b thereof is in close contact with a light incident surface of a sensor 4. The light emit surface 23b of the optical fiber bundle 23 is also provided with an optical surface formed by planar polishing, similarly to the light incident surface 23a. This enhances the adhesion to the imaging element.

The thickness of the optical fiber bundle 23 at the optical axis AX is made small to achieve downsizing of the imaging apparatus 21. Further, an inclination angle αₒ of each optical fiber 23c on the light emit surface 23b of the optical fiber bundle 3 takes a value, which is not 0, at positions other than the optical axis AX.

In the third embodiment, the definitions of an inclination angle αᵢ of the optical fiber 23c on a light incident face 23ca and an inclination angle αₒ of the optical fiber 23c on a light emit face 23cb are the same as those used in the first embodiment. In the third embodiment, Expressions 16 to 18 are also satisfied. Further, in the third embodiment, it is also preferable to satisfy any of Expressions 10 to 15.

For example, it is assumed that an incident angle ωᵢ of the principal ray of imaging light on the farthest optical fiber 23c from the optical axis AX is 60.0 degrees. In this case, when the inclination angle αᵢ is 35.0 degrees, the inclination angle αₒ is 10.0 degrees, and the taper ratio R is 1.5, the emergent angle ωₒ is 26.4 degrees according to Expression 9. This can satisfy Expressions 10 and 13.

In this way, even when the light incident surface 23a of the optical fiber bundle 23 has a curved shape, the emergent angle of light emerging from the optical fiber bundle 23 can be decreased. Hence, the incident angle of light emerging from the optical fiber bundle 23 on the sensor 4 can be set to satisfy an incident angle condition such as to obtain high-efficiency photoreceptive sensitivity. This can suppress the decrease in light amount in a peripheral part of the sensor 4.

While the light incident surface 23a of the optical fiber bundle 23 has a spherical shape in the third embodiment, the present invention is not limited thereto, and the light incident surface 23a may have a parabolic shape or an aspherical shape. The curvature center of the light incident surface 23a can be calculated by using the base spherical surface or the radius of paraxial curvature.

The imaging optical system 22 does not always need to be a ball lens having point symmetry. For example, the imaging optical system 22 may be composed of a plurality of lens groups including an aperture stop, a front lens group disposed on the light incident side of the aperture stop, and a rear lens group disposed on the light emit side of the aperture stop. The front lens group may be formed by an optical system in which the curvature center of a lens surface having the strongest power in the front lens group is at a position near the center of the aperture stop. The rear lens group may be formed by an optical system in which the curvature center of a lens surface having the strongest power in the rear lens group is at a position near the center of the aperture stop. Here, “position near the center of the aperture stop” refers to a range extending from the center of the aperture stop and included in a sphere having a radius corresponding to the length of the wavelength of the principal ray. Each of the front lens group and the rear lens group may be composed of one lens or a plurality of lenses.

According to the third embodiment, it is possible to provide an imaging apparatus that enhances the imaging efficiency in an imaging element.

### Fourth Embodiment

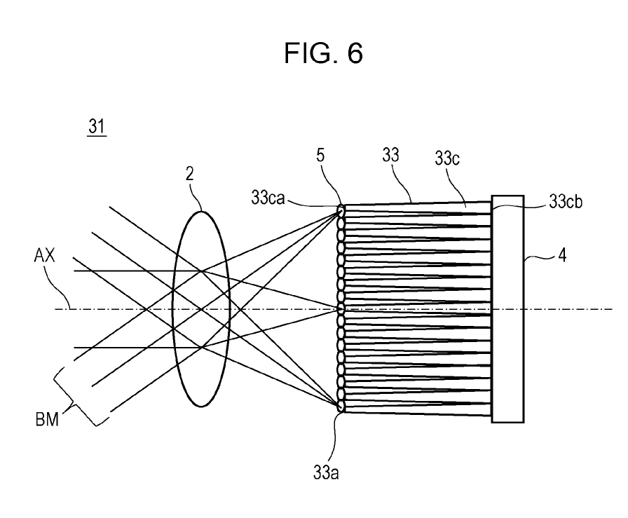

FIG. 6 illustrates a frame format of an example of an imaging apparatus 31 according to a fourth embodiment. The fourth embodiment is different from the first embodiment in the structure of an optical fiber bundle and in that a lens array is provided just in front of the optical fiber bundle. The fourth embodiment is the same as the first embodiment in other respects.

Specifically, both an inclination angle αᵢ of each of the optical fibers 33c on a light incident face 33ca and an inclination angle αₒ of the optical fiber 33c on a light emit face 33cb are 0. In this arrangement, a gap is formed between a core portion of the optical fiber 33c and a core portion of the next optical fiber 33c on a light incident surface 33a of an optical fiber bundle 33. Light incident on the gap is not received by a sensor 4, and this reduces the photoreceptive sensitivity. Accordingly, in the fourth embodiment, a lens array 5 is disposed just in front of the light incident surface 33a of the optical fiber bundle 33. Light emitted from an imaging optical system 2 enters the light incident surface 33a of the optical fiber bundle 33 via the lens array 5.

The lens array 5 is composed of almost the same number of lenses, which have a caliber substantially equal to the pitch of the optical fibers 33c on the light incident surface 33a of the optical fiber bundle 33, as the number of optical fibers 33c. The lens array 5 is disposed on an imaging surface of the imaging optical system 2, and has the function of collecting imaging light from the imaging optical system 2 and guiding the imaging light to the optical fibers 33c. This allows imaging light reaching the gaps between the core portions of the optical fibers 3c on the light incident surface 33a of the optical fiber bundle 33 to enter the optical fibers 33c via the lenses.

The pitch of the lenses in the lens array 5 is set to be smaller than the pitch of the core portions of the optical fibers 33c on the light incident surface 33a of the optical fiber bundle 33. Thus, even when the imaging light has a large incident angle ωᵢ, the coupling efficiency to the optical fibers can be enhanced. The pitch of the core portions refers to the length of a line segment connecting the centers of adjacent core portions.

In the fourth embodiment, the definitions of the inclination angle αᵢ of each optical fiber 33c on the light incident face 33ca and the inclination angle αₒ of the optical fiber 33c on the light emit face 33cb are the same as those used in the first embodiment. In the fourth embodiment, Expressions 16 to 18 are also satisfied. Further, in the fourth embodiment, it is also preferable to satisfy any of Expressions 10 to 15.

For example, it is assumed that, in the farthest optical fiber 33c from the optical axis AX, the incident angle ωᵢ of the principal ray of the imaging light is 40.0 degrees. In this case, when the inclination angle αᵢ is 0.0 degrees, the inclination angle αₒ is 0.0 degrees, and the taper ratio R is 2.0, the emergent angle ωₒ is 18.7 degrees according to Expression 9. This can satisfy Expressions 10, 11, 13, and 14.

This can suppress the decrease in light amount owing to the coupling efficiency in the peripheral part of the sensor 4.

While αᵢ=αₒ=0 in the fourth embodiment, the present invention is not limited to this structure. The fourth embodiment can be applied to any case in which the gap between the core portions of the optical fibers 33c is larger than the length of half the diameter of the core portions on the light incident faces 33ca of the optical fibers 33c.

According to the above-described fourth embodiment, it is possible to provide an imaging apparatus that enhances the coupling efficiency in an imaging element.

The imaging apparatus of the present invention can be used for, for example, a digital camera, a video camera, a camera for a mobile phone, a monitoring camera, and a fiberscope.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-125726, filed Jun. 18, 2014, which is hereby incorporated by reference herein in its entirety.

What is claimed is:

1. An imaging apparatus comprising:
an imaging optical system;
an imaging element; and
an optical fiber bundle composed of a plurality of optical fibers configured to guide light from the imaging optical system to the imaging element,
wherein each of the plurality of optical fibers includes a core portion and a clad portion disposed around the core portion,
wherein a diameter of the core portion on a light emit face of the optical fibers is larger than a diameter of the core portion on a light incident face of the optical fibers, and
wherein an optical fiber not parallel to an optical axis of the imaging optical system satisfies the following expression:
0≦αᵢ<ωᵢ
where αᵢ represents an inclination angle of the optical fiber with respect to the optical axis of the imaging optical system on the light incident face, and ωᵢ represents an angle of a principal ray incident on the optical fiber from the imaging optical system with respect to the optical axis of the imaging optical system.

2. The imaging apparatus according to claim 1, wherein the optical fiber not parallel to the optical axis of the imaging optical system satisfies the following expression:
0≦αₒ≦αᵢ
where αₒ represents an inclination angle of the optical fiber with respect to the optical axis of the imaging optical system on the light emit face.

3. The imaging apparatus according to claim 1, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq {θ}_{A}$$
where αₒ represents an inclination angle of the optical fiber with respect to the optical axis of the imaging optical system on the light emit face, R represents a ratio of the diameter of the core portion on the light emit face of the optical fiber to the diameter of the core portion on the light incident face of the optical fiber, and θ_{A} represents an incident angle on the imaging element such that a photoreceptive sensitivity of the imaging element is 10% of the highest photoreceptive sensitivity.

4. The imaging apparatus according to claim 1, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq {θ}_{B}$$
where αₒ represents an inclination angle of the optical fiber with respect to the optical axis of the imaging optical system on the light emit face, R represents a ratio of the diameter of the core portion on the light emit face of the optical fiber to the diameter of the core portion on the light incident face of the optical fiber, and θ_{B} represents an incident angle on the imaging element such that a photoreceptive sensitivity of the imaging element is 50% of the highest photoreceptive sensitivity.

5. The imaging apparatus according to claim 1, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq {θ}_{C}$$
where αₒ represents an inclination angle of the optical fiber with respect to the optical axis of the imaging optical system on the light emit face, R represents a ratio of the diameter of the core portion on the light emit face of the optical fiber to the diameter of the core portion on the light incident face of the optical fiber, and θ_{C} represents an incident angle on the imaging element such that a photoreceptive sensitivity of the imaging element is 80% of the highest photoreceptive sensitivity.

6. The imaging apparatus according to claim 1, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq 30 [ deg ]$$
where αₒ represents an inclination angle of the optical fiber with respect to the optical axis of the imaging optical system on the light emit face, and R represents a ratio of the diameter of the core portion on the light emit face of the optical fiber to the diameter of the core portion on the light incident face of the optical fiber.

7. The imaging apparatus according to claim 6, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq 20 [ deg ]$$
where αₒ represents the inclination angle of the optical fiber with respect to the optical axis of the imaging optical system on the light emit face, and R represents the ratio of the diameter of the core portion on the light emit face of the optical fiber to the diameter of the core portion on the light incident face of the optical fiber.

8. The imaging apparatus according to claim 7, wherein the optical fiber not parallel to the optical axis of the imaging optical system satisfies the following expression:
$${α}_{o} + {sin}^{- 1} [ \frac{sin ( {ω}_{i} - {α}_{i} )}{R} ] \leq 15 [ deg ]$$
where αₒ represents the inclination angle of the optical fiber with respect to the optical axis of the imaging optical system on the light emit face, and R represents the ratio of the diameter of the core portion on the light emit face of the optical fiber to the diameter of the core portion on the light incident face of the optical fiber.

9. The imaging apparatus according to claim 1, wherein a ratio R of the diameter of the core portion on the light emit face of the optical fiber to the diameter of the core portion on the light incident face of the optical fiber is 2.0 or more.

10. The imaging apparatus according to claim 1, wherein a ratio R of the diameter of the core portion on the light emit face of the optical fiber to the diameter of the core portion on the light incident face of the optical fiber is higher when the optical fiber not parallel to the optical axis is relatively far from the optical axis of the imaging optical system than when the optical fiber is relatively close to the optical axis of the imaging optical system.

11. The imaging apparatus according to claim 1, wherein a ratio R of the diameter of the core portion on the light emit face of the optical fiber to the diameter of the core portion on the light incident face of the optical fiber increases as a distance of the optical fiber from the optical axis of the imaging optical system increases.

12. The imaging apparatus according to claim 1, wherein the inclination angle αᵢ on the light incident face of the optical fiber not parallel to the optical axis of the imaging optical system is smaller when the optical fiber is relatively far from the optical axis of the imaging optical system than when the optical fiber is relatively close to the optical axis of the imaging optical system.

13. The imaging apparatus according to claim 1, wherein the inclination angle αᵢ on the light incident face of the optical fiber not parallel to the optical axis of the imaging optical system decreases as a distance of the optical fiber from the optical axis of the imaging optical system increases.

14. The imaging apparatus according to claim 1, wherein an inclination angle αₒ on the light emit face of the optical fiber not parallel to the optical axis of the imaging optical system is smaller when the optical fiber is relatively far from the optical axis of the imaging optical system than when the optical fiber is relatively close to the optical axis of the imaging optical system.

15. The imaging apparatus according to claim 1, wherein an inclination angle αₒ on the light emit face of the optical fiber not parallel to the optical axis of the imaging optical system decreases as a distance of the optical fiber from the optical axis of the imaging optical system increases.

16. The imaging apparatus according to claim 1, wherein a light incident surface of the optical fiber bundle is concave with respect to the imaging optical system.

17. The imaging apparatus according to claim 16,
wherein the imaging optical system includes an aperture stop, a front lens group disposed on a light incident side of the aperture stop, and a rear lens group disposed on a light emit side of the aperture stop, and
wherein a curvature center of a lens surface having the strongest power in the front lens group is located along the optical axis at a position near a center of the aperture stop.

18. The imaging apparatus according to claim 17, wherein a curvature center of a lens surface having the strongest power in the rear lens group is at a position near the center of the aperture stop.

19. The imaging apparatus according to claim 16, wherein the imaging optical system has point symmetry.

20. The imaging apparatus according to claim 1, further comprising:
a lens array including a plurality of lenses configured to cause light emitted from the imaging optical system to be incident on a light incident surface of the optical fiber bundle.

21. The imaging apparatus according to claim 20, wherein a pitch of the plurality of lenses is smaller than a pitch of the core portions of the plurality of optical fibers.

22. The imaging apparatus according to claim 1, wherein the inclination angle of the optical fiber with respect to the optical axis of the imaging optical system on the light incident face is equal to an inclination angle of the optical fiber with respect to the optical axis of the imaging optical system on the light emit face.

23. The imaging apparatus according to claim 1, wherein the inclination angle of the optical fiber with respect to the optical axis of the imaging optical system on the light incident face is greater than an inclination angle of the optical fiber with respect to the optical axis of the imaging optical system on the light emit face.
